(19) United States
(12) Patent Application Publication
(10) Pub. No.: US 2026/0075351 A1
(43) Pub. Date: Mar. 12, 2026

(54) DETACHABLE BOOM MICROPHONE FOR HEADPHONES

(71) Applicant: Apple Inc., Cupertino, CA (US)

(72) Inventors: Gerhard A. Schneider, Cudrefin (CH); Son T. Pham, San Jose, CA (US)

(73) Assignee: Apple Inc., Cupertino, CA (US)

(21) Appl. No.: 18/883,728

(22) Filed: Sep. 12, 2024

(51) Int. Cl. H04R 1/10; H04R 1/04; H04R 1/08; H04R 1/32

(52) U.S. Cl. CPC H04R 1/1075; H04R 1/04; H04R 1/08; H04R 1/1008; H04R 1/326; H04R 2201/107; H04R 2420/05; H04R 2420/07; H04R 2420/09

(57) ABSTRACT

Headphones comprising: a headband having first and second opposing ends; a first earpiece coupled to the first end of the headband and comprising a first audio driver; a second earpiece coupled to the second end of the headband and comprising a second audio driver, wherein at least one of the first and second earpieces comprises a first directional microphone configured to and aligned to capture a user's voice; a boom microphone configured to be removably attached to one of the first or second earpieces, the boom microphone comprising a second directional microphone disposed at a distal end of a flexible boom; and a processor configured to, in response to detecting that the boom microphone is operably attached to the first or second earpiece, deactivate the first directional microphone.

### BACKGROUND OF THE INVENTION

This disclosure relates generally to headphone systems and in particular to a boom microphone that can be removably attached to headphones to improve the quality of sound captured by the headphones.

Headphones are a common type of personal audio device that can provide superior acoustic performance as compared to more compact earbud systems. Headphones generally include one or two audio-producing earpieces (also referred to as “ear cups”) that are designed to be worn over the ear or on the ear. The ear cups are connected to a headband, which can help to hold the ear cups in place and can also provide an electrical connection between the ear cups.

A number of headphones that are currently commercially available are wireless headphones that enable a user to wirelessly stream audio from a wireless audio source, such as a smart phone, tablet computer, laptop computer or the like. Such headphones also typically include one or more microphones that enable the user to use the headphones to participate in cellular or internet-based phone calls, chats or other services in which the headphones capture sound in the user's environment, such as the user's voice, and send the sound back to the wireless audio source.

Since the most common use for microphones in headphones is to capture a user's voice (e.g., during a phone call), some headphones include one or more microphones that are directional in nature. That is, the headphone microphones are designed to primarily capture sound from a specific direction that is aligned with a user's mouth. In many instances, such a directional microphone helps isolate the source of sound for the microphone to the user's voice and reduces background noise that may be in the user's environment.

In some use scenarios, however, directional microphones are not able to effectively reduce background noise and can even pickup and amplify certain background noises making them louder to a person on the other end of the phone call than to the user wearing the headphones. For example, directional microphones that are aligned to capture a user's voice can also be aligned to capture the clicking of keyboard keys when the user of the headphones is typing on a keyboard.

To further improve on reducing background noise and isolating only a user's voice, some headphones and headsets include a boom microphone that extends away from one of the headphone ear cups to a position directly in front of a user's mouth. A directional microphone can then be positioned at the end of the boom and aligned directly towards the user's mouth. Such a boom microphone can be very effective at capturing a user's voice and reducing background noise that might otherwise be generated from a source that is aligned with a directional microphone in one or both of the ear cups, such as keyboard noise. Boom microphones tend to be awkward in size and/or bulky, however, and can interfere with a user's enjoyment of headphones when the boom microphone is not needed.

Accordingly, improvements in headphone design are desirable.

### BRIEF SUMMARY OF THE INVENTION

The present disclosure describes various embodiments of headphones that include one or more directional microphones disposed within one or both earpieces of the headphones and that are configured and aligned to primarily capture sound from a specific direction that is aligned with a user's mouth. Headphones according to embodiments disclosed herein can also include a boom microphone that can be removably attached to the headphones. In some embodiments, the headphones can include a female receptacle connector on one or both of the earpieces and the boom microphone can include a corresponding male plug connector that can be mated with the receptacle connector. The boom microphone can include a directional microphone positioned at or near a distal end of the boom and aligned towards the user's mouth, and the headphones can further include a processor and/or circuitry that can detect when the boom microphone is operatively coupled to one of the earpieces to activate the microphone within the boom microphone and deactivate one or more of the directional microphones in the headphone earpieces. By deactivating the earpiece microphones when the boom microphone is enabled, embodiments disclosed herein ensure that a user's speech can be captured and isolated from background noise, such as keystrokes, that the earpiece directional microphone(s) might otherwise pick up.

According to some embodiments, headphones and a detachable boom microphone are provided. The headphones can include: a headband having first and second opposing ends; a first earpiece coupled to the first end of the headband and comprising a first audio driver; a second earpiece coupled to the second end of the headband and comprising a second audio driver, wherein at least one of the first and second earpieces comprises a first directional microphone configured to and aligned to capture a user's voice. The boom microphone can be configured to be removably attached to one of the first or second earpieces, and can include a second directional microphone disposed at a distal end of a flexible boom. The processor in the headphones can be configured to, in response to detecting that the boom microphone is operably attached to the first or second earpiece, deactivate the first directional microphone.

In some embodiments, headphones can include: a headband having first and second opposing ends; a first earpiece coupled to the first end of the headband and comprising a first audio driver aligned to direct sound towards a user's first ear when the headband is worn by the user, wherein the first earpiece comprises a receptacle connector having an opening at an exterior surface of the first earpiece; a second earpiece coupled to the second end of the headband and comprising a second audio driver aligned to direct sound towards a user's second ear when the headband is worn by the user, wherein at least one of the first and second earpieces comprises a first directional microphone configured to and aligned to capture a user's voice when the headband is worn by the user; a boom microphone comprising a plug connector and a second directional microphone disposed at opposite ends of an elongated flexible boom that can be bent into a desired position by a user and retain that position, wherein the boom microphone is configured to be removably attached to the first earpiece by inserting the plug connector into the opening of the receptacle connector to mate the plug connector to the receptacle connector; and a processor configured to, in response to detecting that the boom microphone is operably attached to the first earpiece, deactivate the first directional microphone.

In some embodiments, a detachable boom microphone is provided that includes: an elongated flexible boom having a first and second opposing ends; a plug connector disposed at the first end, the plug connector having a connector tab extending away from a connector housing and a plurality of contacts disposed along the connector tab, the plurality of contacts comprising a power contact, a ground contact, and a pair of differential data contacts; a microphone housing disposed at the second end; a directional microphone coupled to the microphone housing; a pulse density modulation circuit disposed within the microphone housing and operatively coupled to convert an analog signal voltage output of the microphone into a pulse density modulated digital stream; a microcontroller disposed within the connector housing and configured to receive the pulse density modulated digital stream and convert the digital stream to differential pairs that can be transmitted over the pair of differential data contacts; wherein the elongated flexible boom is made from a semi-rigid material that is configured to be bent into a desired position and retain that position.

In various implementations, the detachable boom microphone can include one or more of the following features. The boom microphone can further include a mute button that can be activated to mute the second directional microphone. The boom microphone can further include an LED at its distal end that can be switched ON and OFF to indicate whether the second directional microphone is muted or not. The boom microphone can further include a third microphone configured to detect background noise behind the second microphone. The boom microphone can further include a computer-readable memory that stores identifying information that can be communicated to the processor in the headphones to identify features of the boom microphone. The second directional microphone can be disposed within and coupled to a microphone housing. A windscreen can be disposed around the microphone housing to cover the second microphone. The boom microphone can include a plug connector having a tab sized and shaped to be inserted into a receptacle connector on the headphones. The plug connector can be a USB-C plug connector. The plug connector can have a connector tab extending away from a connector housing and a plurality of contacts disposed along the connector tab, the plurality of contacts comprising a power contact, a ground contact, and a pair of differential data contacts.

In various implementations, the headphones can include one or more of the following features. At least one of the first and second earpieces can include a receptacle connector having a receiving cavity into which a plug connector on the boom microphone can be inserted to operably connect the boom microphone to the headphones. The headphones can further include a receptacle connector having an opening at an exterior surface of either the first or second earpiece. The receptacle connector can be a USB-C port. The headphones can further include a pulse density modulation circuit operatively coupled to convert an analog signal voltage output of the microphone into a pulse density modulated digital stream. The headphones can further include a microcontroller configured to receive the pulse density modulated digital stream and convert the digital stream to differential pairs that can be transmitted over a pair of differential data contacts on the plug connector.

To better understand the nature and advantages of the present invention, reference should be made to the following description and the accompanying figures. It is to be understood, however, that each of the figures is provided for the purpose of illustration only and is not intended as a definition of the limits of the scope of the present invention. Also, as a general rule, and unless it is evident to the contrary from the description, where elements in different figures use identical reference numbers, the elements are generally either identical or at least similar in function or purpose.

### BRIEF DESCRIPTION OF THE DRAWINGS

FIG. 1 is a simplified illustration of an exemplary wireless audio system according to some embodiments that includes a host device configured as a smart phone and a pair of headphones;

FIG. 2 is a simplified block diagram of various components of a wireless audio wireless system according to some embodiments;

FIG. 3 is a simplified perspective view of a pair of headphones according to some embodiments worn by a user;

FIG. 4A is a simplified top plan view of a detachable boom microphone according to some embodiments;

FIG. 4B is a simplified side plan view of the detachable boom microphone depicted in FIG. 4A;

FIGS. 5A and 5B are simplified illustrations showing a detachable boom microphone according to some embodiments ready to be connected to a pair of headphones (FIG. 5A) and connected to the headphones (FIG. 5B);

FIG. 6 is a flowchart depicting steps of a method in accordance with some embodiments;

FIG. 7 is a flowchart depicting steps of a method in accordance with some embodiments; and

FIG. 8 is a simplified schematic view of circuitry associated with a detachable boom microphone according to some embodiments.

### DETAILED DESCRIPTION OF THE INVENTION

Embodiments disclosed herein pertain to headphones that include at least a first directional microphone disposed within an earpiece of the headphones and configured to primarily capture sound from a specific direction aligned with a user's mouth. The disclosed headphones also include a boom microphone that can be removably attached to the headphones. The boom microphone can include a second directional microphone (e.g., positioned at or near a distal end of the boom) that can be aligned towards the user's mouth, and the headphones can further include a processor and/or circuitry that can detect when the boom microphone is operatively coupled to one of the earpieces to activate the second directional microphone within the boom microphone while deactivating the first directional microphone in the headphone earpiece. By deactivating the earpiece directional microphone when the boom microphone is enabled, embodiments disclosed herein ensure that a user's speech can be captured and isolated from background noise, such as keystrokes, that the earpiece directional microphone(s) might otherwise pick up.

As used herein, the term “headphones” refers to portable audio devices that are designed to be worn on or around a user's head and typically include left and right earpieces connected to each other by a headband. Each earpiece typically includes an earcup and an earpad attached to the earcup o provide a comfortable fit. The earcup can house a driver (e.g., a small speaker) that converts an electrical signal to a corresponding sound that can be heard by the user. Traditional headphones include both over-ear headphones (sometimes referred to as either circumaural or full-size headphones) that have earpads that fully encompass a user's ears, and on-ear headphones (sometimes referred to as supra-aural headphones) that have earpads that press against a user's ear instead of surrounding the ear.

### Example Wireless Audio System

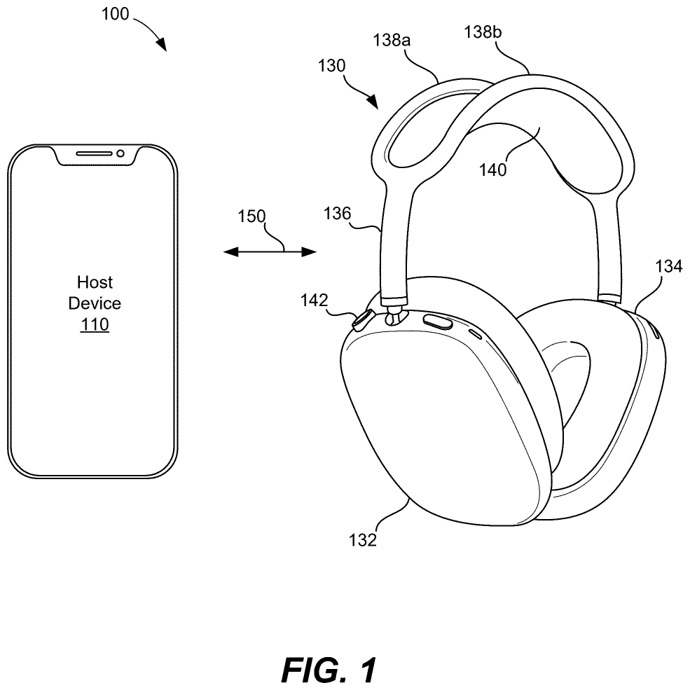

FIG. 1 is an example of a wireless audio system 100 according to some embodiments. System 100 can include a host device 110 and a pair of headphones 130. Host device 110 is depicted in FIG. 1 as a smart phone but can be any electronic device that can transmit audio data to wireless headphones 130. Other, non-limiting examples of suitable host devices 110 include a laptop computer, a desktop computer, a tablet computer, a smart watch, an audio system, a video player, and the like. Headphones 130 can include first and second earpieces 132, 134 (e.g., left and right ear cups and earpad cushions) that are connected to each other by a headband 136. Each earpiece 132, 134 can each house, in its respective ear cup, an audio driver (not shown) to deliver sound directly to a user's ear as well as one or more microphones as discussed below.

As depicted graphically in FIG. 1, host device 110 can be wirelessly communicatively coupled with wireless headphones 130 through a wireless communication link 150, which can be a known and established wireless communication protocol, such as a Bluetooth protocol, a Wi-Fi protocol, or any other acceptable protocol that enables electronic devices to wirelessly communicate with each other. Thus, host device 110 can exchange data directly with wireless headphones 130, such as audio data, which can be transmitted over wireless link 150 to the wireless headphones 130 for play back to a user. Additionally, audio data can be received by host device 110 as recorded/inputted from microphones in the wireless headphones 130. Host device 110 and wireless headphones 130 can also exchange data with each other, such as data indicating the battery charge level data for headphones 130, data indicating the pairing status of wireless headphones 130, and the like.

As will be appreciated herein, wireless headphones 130 can include several features can enable the devices to be comfortably worn by a user for extended periods of time and even all day. For example, headband 136 can include a frame with a central opening formed between two opposing segments 138a, 138b. A mesh canopy 140 can extends across the opening and be configured with a u-shaped cross section that allows the mesh to conform to the curvature of a user's head. The headphones can also provide one or more user input devices 142, such as a crown and/or button, that enable a user to control features of the headphones and interface to host device 110 so that the user may not need to utilize a graphical interface of host device 110 for certain functions or operations of either the wireless headphones or the host device. In other words, wireless headphones 130 can be sufficiently sophisticated that they can enable the user to perform certain day-to-day operations from host device 110 solely through interactions with wireless headphones 130. This can create further independence from host device 110 by not requiring the user to physically interact with, and/or look at the display screen of, host device 110, especially when the functionality of wireless headphones 130 is combined with the voice control capabilities of host device 110. Thus, in some instances wireless headphones 130 can enable a true hands-free experience for the user.

While not shown in FIG. 1, wireless headphones 130 can be stored within a case that can protect the headphones 130 from being lost and/or damaged when they are not in use. In some embodiments, the case can also provide power to recharge the batteries of wireless headphones 130.

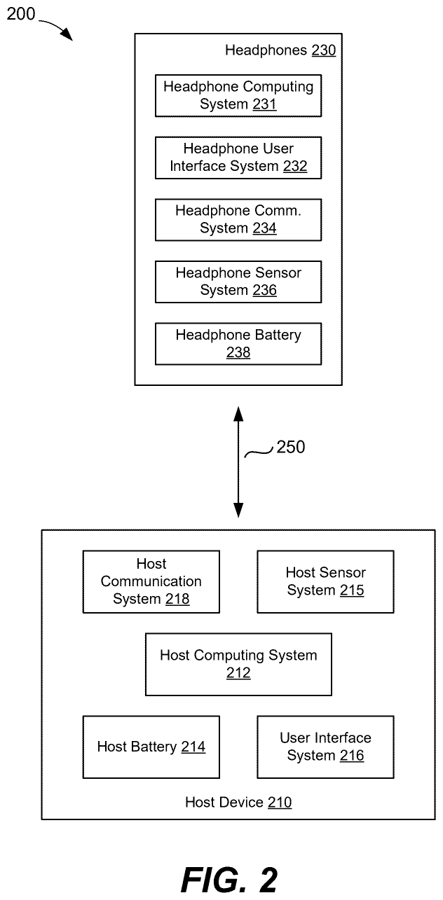

Details of an example pair of wireless headphones, which can be representative of wireless headphones 130 are discussed below. First, however, reference is made to FIG. 2, which is a simplified block diagram of various components of a wireless audio system 200 according to some embodiments that includes a host device 210 and a pair of wireless headphones 230. System 200 can be representative of system 100 shown in FIG. 1 with host device 210 and wireless headphones 230 being representative of host device 110 and wireless headphones 130, respectively.

Wireless headphones 230 can include a computing system 231, which executes computer-readable instructions stored in a memory bank (not shown) for performing a plurality of functions for wireless headphones 230. Computing system 231 can be one or more suitable computing devices, such as microprocessors, computer processing units (CPUs), digital signal processing units (DSPs), field programmable gate arrays (FPGAs), application specific integrated circuits (ASICs) and the like as well as various discrete components.

Computing system 231 can be operatively coupled to a user interface system 232, communication system 234, and a sensor system 236 for enabling wireless headphones 230 to perform one or more functions. For instance, user interface system 232 can include a driver (e.g., speaker) for outputting sound to a user, one or more LEDs for providing visual notifications to a user, a pressure sensor or a touch sensor (e.g., a resistive or capacitive touch sensor) for receiving user input, and/or any other suitable input or output device. As discussed in more detail below, user interface system 232 can also include one or more microphones for inputting sound from the environment or the user and for implementing noise cancelling features. In some embodiments, user interface system 232 can include multiple directional (beam forming) microphones disposed in the earpieces of the headphones and aligned to, when the headphones are worn, catch as much as possible of the user's voice.

Communication system 234 can include wireless and wired communication components for enabling wireless headphones 230 to send and receive data/commands from host device 210. For example, in some embodiments communication system 234 can include circuitry that enables wireless headphones 230 to communicate with host device 210 over wireless link 250 via a Bluetooth or other wireless communication protocol. Sensor system 236 can include proximity sensors (e.g., optical sensors, capacitive sensors, radar, etc.), accelerometers, microphones, and any other type of sensor that can measure a parameter of an external entity and/or environment.

Wireless headphones 230 can also include a battery 238, which can be any suitable energy storage device, such as a lithium-ion battery, capable of storing energy and discharging stored energy to operate the headphones. The discharged energy can be used to power the electrical components of headphones 230. In some embodiments, battery 238 can be a rechargeable battery that enables the battery to be repeatedly charged as needed to replenish its stored energy. For instance, battery 238 can be coupled to battery charging circuitry (not shown) that is operatively coupled to receive power from an external power source. In some embodiments, power can be received by wireless headphones device 230 from an external power source via electrical contacts that are part of a receptacle connector, such as a Lightning Connector or USB-C connector, charging case 250. In some embodiments, power can be wirelessly received by headphones 230 via a wireless power receiving coil within the headphones.

Host device 210, to which wireless headphones 230 can be considered an accessory, can be a portable electronic device, such as a smart phone, tablet, or laptop computer. Host device 210 can include a host computing system 212 coupled to a battery 214 and a host memory bank (not shown) containing lines of code executable by host computing system 212 for operating host device 210. Host device 210 can also include a host sensor system 215, e.g., accelerometer, gyroscope, light sensor, and the like, for allowing host device 210 to sense the environment, and a host user interface system 216, e.g., display, speaker, buttons, touch screen, and the like, for outputting information to and receiving input from a user. Additionally, host device 210 can also include a host communication system 218 for allowing host device 210 to send and/or receive data from the Internet or cell towers via wireless communication, e.g., wireless fidelity (Wi-Fi), long term evolution (LTE), code division multiple access (CDMA), global system for mobiles (GSM), Bluetooth, and the like. In some embodiments, host communication system 218 can also communicate with communication system 234 in wireless headphones 230 via a wireless communication link 250 so that host device 210 can send audio data to wireless headphones 230 to output sound and receive data from wireless headphones 230 to receive user inputs. The communication link 250 can be any suitable wireless communication line such as Bluetooth connection. By enabling communication between host device 210 and wireless headphones 230, the headphones 230 can enhance the user interface of host device 210. In communicating with wireless headphones 230, host device 210 can use its sensors or microphones (as well as the headphone sensors) to adjust the sound rendering to, for example, orient a stereo scene depending on user head rotation, adjust sound level volume depending on environmental noise level, etc.

### Directional Microphones in Earpieces

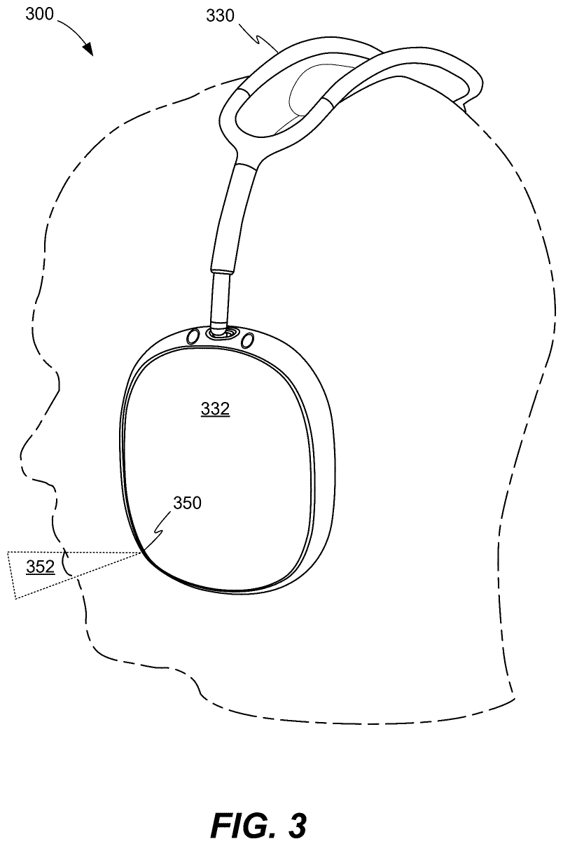

Headphones 130 and 230 can include one or more directional microphones that are configured and aligned to pick up speech from a user's mouth. To illustrate, reference is made to FIG. 3, which is a simplified perspective view of a pair of headphones 330 according to some embodiments worn by a user 300. Headphones 330 can be representative of headphones 130 and 230. Headphones 330 can include one or more directional microphones positioned within an interior cavity of housings that form the left and/or right earpieces of the headphones.

As shown, a directional microphone 350 is housed within left ear cup 332. Directional microphone 350 is configured and aligned to, when headphones 330 are worn by user 300, pick up sound in a direction aligned with the mouth of user 300 as indicated by cone 352. In this manner, directional microphone 350 can be very effective at isolating sounds emanating from the user's mouth (e.g., speech) from ambient and background noise that might be present in the general environment in which user 300 is present. In some instances, however, the alignment of directional microphone 350 is not able to effectively reduce background noise and can even pickup and amplify certain background noises making them louder to a person on the other end of a phone call than the noises are to user 300. For example, while directional microphone 350 is aligned to capture the voice of user 300, the directional nature of microphone 350 can also result in it capturing the clicking of keyboard keys when user 300 is typing on a keyboard, the chopping of vegetables if the user is cooking or other noises that emanate from directly in front of user 300. While not shown in FIG. 3, headphones 330 can also include one or multiple additional microphones in one or both of the left and right earpieces for noise-cancellation features.

### Detachable Boom Microphone

Embodiments disclosed herein provide a boom microphone that can be removably attached to headphones 330. In some embodiments, left ear cup 332 (and/or the right ear cup, which is not shown in FIG. 3), can include a female receptacle connector that enables a boom microphone, which has a corresponding male plug connector, to be operatively coupled to headphones 330. In some embodiments, the male and female connectors can be USB-C connectors that enable headphones 330 to provide power to boom microphone 400 and also provide a data path that enables data to be exchanged between the headphones 330 and boom microphone 400.

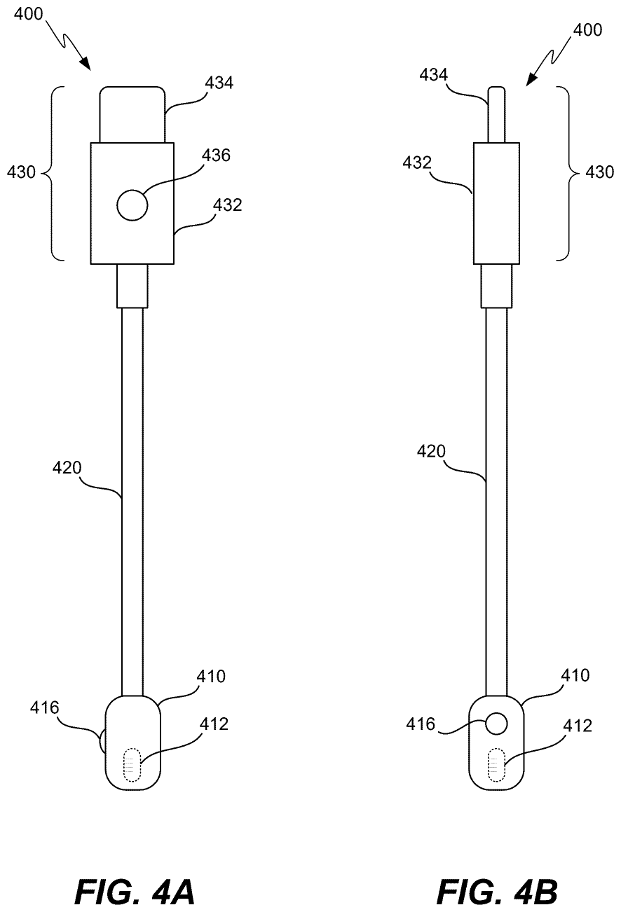

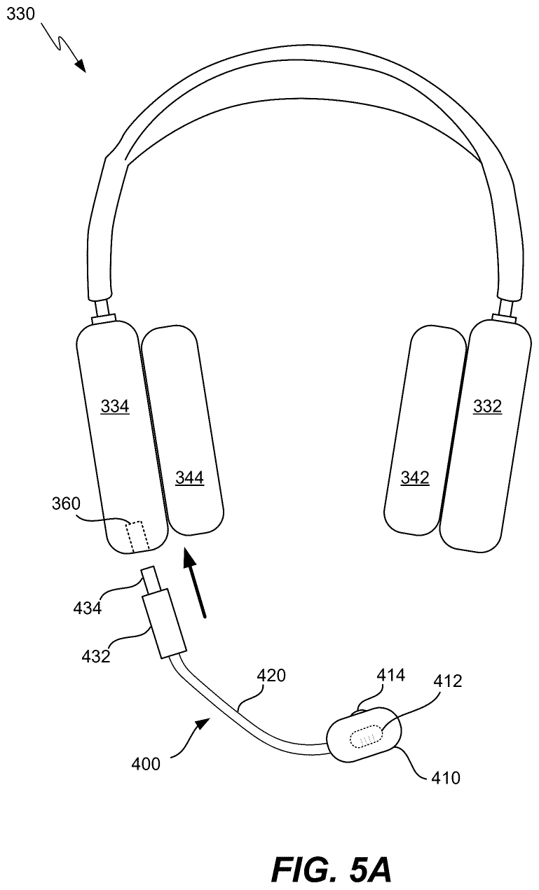

FIG. 4A is a simplified top plan view of a detachable boom microphone 400 according to some embodiments, and FIG. 4B is a simplified side plan view of the detachable boom microphone 400 depicted in FIG. 4A. As shown in FIGS. 4A and 4B, boom microphone 400 can include a microphone housing 410 positioned at a distal end of a flexible boom 420. A plug connector 430, such as a USB-C, Lightning Connector, or other appropriate connector, can be disposed at the opposite end of boom 420. Plug connector 430 can include a connector housing 432 and a tab or plug 434 with one or more data contacts (not shown) that can be inserted into and mated with a corresponding female connector on a pair of headphones, such as headphones 130, 230 or 330, to enable data (e.g., captured sound) to be transferred from boom microphone 400 to the headphones.

Boom 420 can be made from wire or similar semi-rigid material that can be moved into a desired position by a user and retain that position. Boom 420 has a sufficient length and flexibility to enable microphone 412 to be positioned directly in front of and facing the mouth of a user wearing headphones that have boom microphone 400 connected thereto. One or more signal wires (not shown in FIG. 4A or 4B) can extend along the length of boom 420 to connect circuitry disposed within microphone housing 410 to circuitry disposed within connector housing 432.

Microphone housing 410 can include a directional microphone 412 disposed within the housing that, when positioned in front of and aligned directly towards the mouth of user 300, is very effective at capturing the user's voice. When aligned as such, microphone 412 is also very effective at filtering out background noise generated from a source behind microphone 412 but aligned with a directional microphone in one or both of the earpieces, such as the clicking noise of a computer keyboard or chopping of vegetables while a user is preparing food. Such noises would generally be picked up by a directional microphone, such as microphone 350, disposed within one of the earpieces of the headphones. As described below, however, embodiments can deactivate directional microphone 350 when boom microphone 400 is connected to the headphones to prevent such noises from interfering with the audio picked up by microphone 412.

In some embodiments, boom microphone 400 can actually include multiple microphones. For example, in some embodiments boom microphone 400 can include a first directional microphone, such as microphone 412, having a cardioid pickup pattern that can be directed at the user's mouth and a second microphone (not shown) for noise cancellation features of the headphones. In some embodiments, the second microphone can be a directional microphone configured and aligned to pickup sound behind the first microphone (i.e., away from the user's mouth), and in some embodiments the second microphone can have a bi-directional, hypercardioid or other pickup pattern that can pickup sound both in front of and behind the microphone. A person of skill in the art will appreciate that these are just examples of possible microphone arrangements and embodiments are not limited to the specific microphone arrangement depicted in FIGS. 4A and 4B. For example, in other embodiments boom microphone 400 can include more than one or two microphones and can include microphones in other locations, such as in the connector, that can be used for noise cancellation features.

Microphone housing 410 can be surrounded by a protective windscreen (not shown) that is sometimes referred to as a “wind muff”. The protective windscreen can be made from foam or a similar material and fits over microphone housing 410 and microphone 412 to reduce wind noise and other interference that can reduce the quality of sound captured by microphone 412 when recording audio.

Boom microphone 400 can also include a mute button 436 and an LED 416. Mute button 436 can be positioned at an exterior surface of connector housing 432 that is readily accessible to user 300 when the boom microphone is attached to the headphones thus enabling the user to easily depress or select the mute button to activate and deactivate a mute mode in which boom microphone 400 does not send sound back to headphones 330. In some embodiments, button 436 can be a toggle switch that has two positions: mute and unmute. In other embodiments, button 436 can change the state of the microphone from mute to unmute or from unmute to mute, each time the button is depressed. LED 416 can indicate whether the mute function is activated (e.g., LED on) or not (e.g., LED off) and can be positioned at a distal end of flexible boom 420 such that user 300 can quickly and easily visually confirm the status of the mute function.

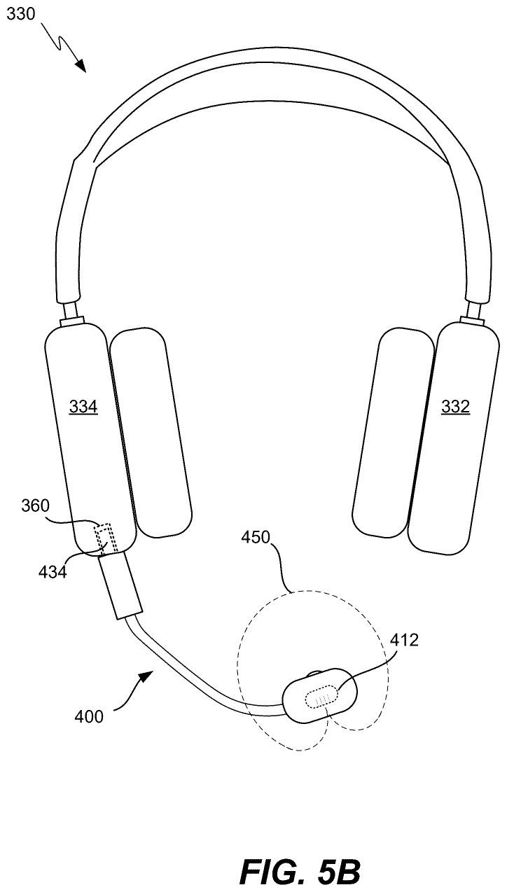

Reference is now made to FIG. 5A which is a simplified illustrations showing detachable boom microphone 400 according to some embodiments in a detached state ready to be connected to a pair of headphones 330. As shown, headphones 330 include left and right ear cups 332, 334 along with left and right ear pads 342, 344. Headphones 330 further include a receptacle connector 360 having an opening at an exterior surface of right earpiece 334 that is sized and shaped to accept plug 434 of boom microphone connector 430.

In FIG. 5B, detachable boom microphone 400 is shown connected to headphones 330. Specifically, plug 434 of connector 430 of the boom microphone is mated with receptacle connector 360 of headphones 330 such that the plug 434 is inserted into the cavity (not labeled) of the receptacle connector. When connected in this manner, a user can adjust (bend) flexible boom 420 to position microphone 412 directly in from of and aligned towards the user's mouth. In some embodiments, microphone 412 can be configured to have a cardioid pickup pattern 450 that enables the microphone to capture the user's voice while reducing background noise emanating from in front of the user but behind microphone 412. In still other embodiments, a cardioid or similar radiation pattern can be achieved by signal processing techniques using multiple microphones 412. Additionally, in some embodiments, when the boom and microphone are so positioned, LED 416 can be aligned such that the LED is visible only to user 330 and is not generally visible to other people in the vicinity of the user so as to not disturb or otherwise distract other people.

While not shown in FIG. 5A or 5B, as discussed above, headphones 330 can include one or more directional (beam forming) microphones 350 in either or both ear cups 332, 334 in order to catch as much of a user's voice as possible. The inclusion of such directional microphones 350 is very helpful when boom microphone 400 is not attached to the headphones. Since the microphones 350 focus the beam to the front of the user, however, they are prone to catching all the noise coming from the front of the user, which might include traffic noise, keyboard noise, cooking noise, etc.

### Example Methods

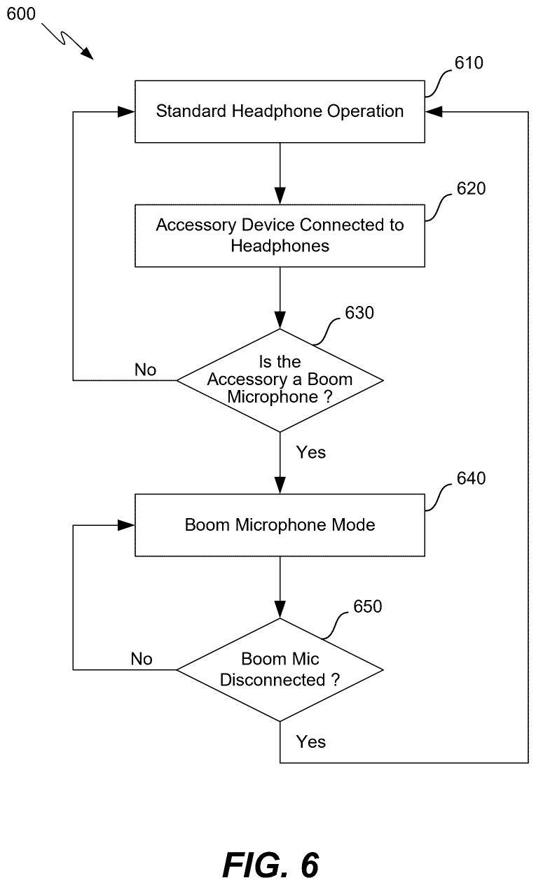

Embodiments disclosed herein can deactivate the directional microphones 350 in the ear cups 332, 334 when headphones 330 determine that boom microphone 400 is operatively coupled to the headphones. In this manner, embodiments prevent the microphones 350 from picking up noise from in front of the user and can rely exclusively on boom microphone 400 to capture a user's voice when the boom microphone is connected and enabled. To illustrate, reference is made to FIG. 6, which is a flowchart depicting steps associated with a method 600 in accordance with some embodiments.

Method 600 starts with headphones, such as headphones 330, operating in what is referred to herein as “standard mode” (block 610). In standard mode, the one or more directional microphones within the earpieces of headphones 330 are enabled and can actively pick up sound, such as speech of the user wearing the headphones. When a device is plugged into the receptacle connector of the headphones (block 620), the headphones determine whether the connected device is a boom microphone (block 630). In some embodiments, accessory devices can store information, such as an accessory ID or descriptor block, that identifies the type of accessory being connected and can transmit the identifying information (e.g., accessory ID) over a data pin to the headphones when a connection is initially made. For example, if connector is a USB-C connector, the identifying information can be communicated over the CC pin; if the connector is a Lightning connector, the identifying information can be communicated over the ACC_ID pin. The headphones can look up the identifying information(e.g., accessory ID) to identify the type of device that was connected in block 620 and take appropriate action. In other embodiments, other known techniques can be used by the headphones to determine whether the connected accessory is a boom microphone, such as detecting the resistance of the connected device.

If the headphones determine that a boom microphone was connected to the headphones (block 630), they can activate what is referred to herein as “boom microphone mode” (block 640). In boom microphone mode, the headphones enable the microphone in the boom microphone (e.g., microphone 412) so that it can capture a user's speech and disable the one or more directional microphones in the earpieces. Disabling the directional microphones prevents those microphones from inadvertently capturing undesirable background noise, such as keystrokes, vegetable chopping, etc. discussed above. Microphones within the headphones that are used for noise cancellation features can remain active in boom microphone mode.

The headphones can keep the boom microphone enabled in boom microphone mode until they detect that the boom microphone is disconnected from the headphones (block 650) when, for example, connector 430 is unplugged from the corresponding connector on the headphones. Once disconnected, the headphones can return to standard mode by reactivating the one or more directional microphones in the earpieces (block 610).

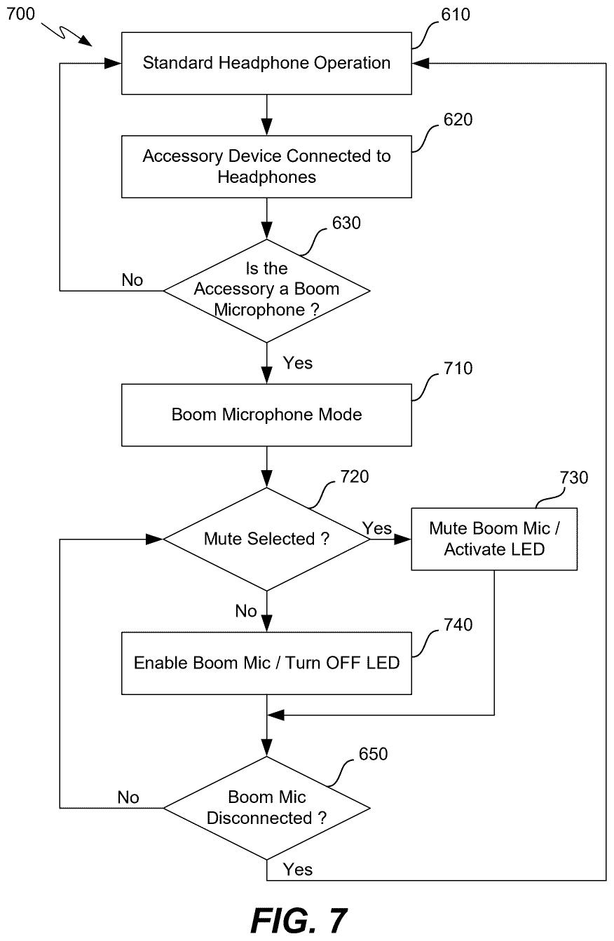

There are times when the user wearing the headphones may want to mute the boom microphone. As described above, in some embodiments this can be done by activating (e.g., depressing) mute button 436. FIG. 7 is a simplified flowchart depicting steps associated with a method 700 in accordance with some embodiments. Some of the steps in method 700 can be identical to or substantially the same as those discussed above with respect to FIG. 6. Thus, for the sake of convenience and brevity, such steps are given the same reference number in FIG. 7 as used in FIG. 6 and not discussed further.

Once method 700 determines that a boom microphone is connected to the headphones (block 630), the headphones can enter boom microphone mode by deactivating the one or more microphones in the earpieces of the headphones (block 710). The headphones can then check whether the mute button is activated (block 720). If the mute button is activated, headphones can turn OFF the boom microphone and activate LED (block 730) until the mute button is deactivated. If the mute button is not selected, the headphones can enable the boom microphone without turning on the LED (block 740). If the LED was previously ON (e.g., the microphone had been muted), the LED can be switched OFF in block 740 as well.

In some embodiments, headphones 330 can include a user-input, such as a button or touch sensitive surface, directly on one or both of the earpieces that can be selected by a user to mute and unmute the boom microphone in addition to, or instead of, button 436. Additionally, in some embodiments a voice command can be used to mute and unmute the boom microphone.

As long as the boom microphone remains connected to the headphones and the headphones are turned ON, the headphones can periodically check to determine if the mute function is activated (block 710). For example, in some embodiments the headphones can poll the mute button status at regular intervals, such as every 10 msec or every 100 msec, to determine if the mute button is activated. In other embodiments, circuitry within the boom microphone can alert the headphones when the mute button is activated and deactivated. Once the headphones detect that the boom microphone is disconnected from the headphones (block 650), the headphones can return to standard mode by reactivating the one or more directional microphones in the earpieces (block 610).

### Example Schematic Diagram

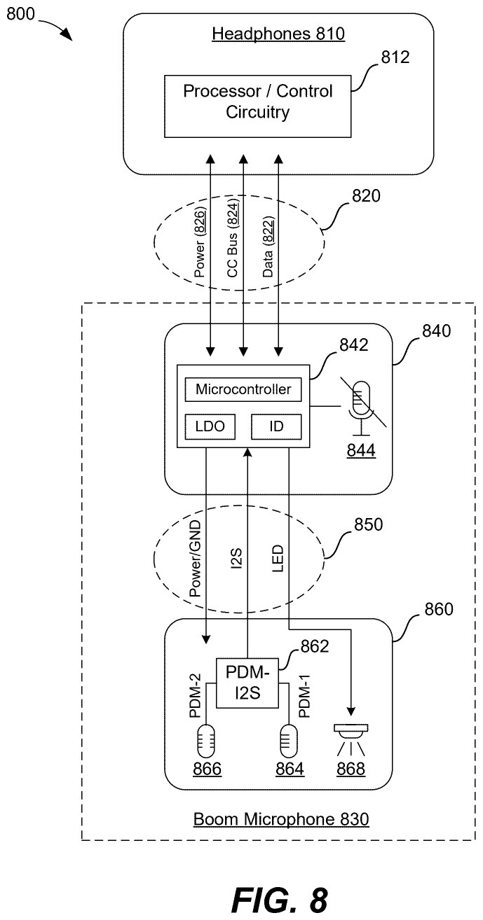

FIG. 8 is a simplified schematic diagram of an audio system 800 according to some embodiments. As shown, audio system 800 includes a pair of wireless headphones 810 and a boom microphone 830. Headphones 810 can be representative of any of the headphones discussed herein including headphones 130, 230, 330 and 830 and includes one or more processors and/or control circuitry 812 that can be representative of headphone computing system 231 discussed above with respect to FIG. 2. Circuitry 812 can provide power to and exchange data with boom microphone 830 when the boom microphone is physically connected to (e.g., plugged into) the headphones via a connector interface 820 as described above. For example, the connector interface 820, which can be a USB-C or other appropriate interface, between headphones 810 and boom microphone 830 can include separate pins (not shown) to transmit data over one or more data lines 822, an identifier that indicates the type of device connected to the headphones over an bus 824 and power over power (and ground) lines 826. When connector interface 820 is a USB-C connector, data lines 822 can be transmitted over either the RX and TX differential pins of the D+ and D− differential pairs. The accessor identifier can be transmitted over the CC (channel configuration) pins, power can be transmitted over the Vbus pin, and ground over the ground pin.

Boom microphone 830 can be representative of any of the embodiments of boom microphones discussed herein including boom microphone 400. As shown, boom microphone 830 can include a connector end 840 and a microphone end 860 joined together by, and disposed at opposite ends of, a flexible boom 850. Multiple lines can run through flexible boom 850 enabling circuitry in connector end 840 to power and exchange data with circuitry in microphone end 860. In the depicted embodiment, flexible boom 850 can include an I2S channel for transmitting two-channels of digital audio via a synchronous, serial communication protocol, power and ground lines, and a signal line (LED) that can transmit a signal to turn LED 868 either ON or OFF. Embodiments are not limited to the particular signal lines or communication protocols shown in FIG. 8, however, and other embodiments can rely on other communication protocols and appropriate signal lines as can be determined by a person of ordinary skill in the art.

Microphone end 860 can include a directional microphone 864 that can be pointed directly towards a user's mouth to capture speech as discussed above. In some embodiments, microphone end 860 can also include an LED 868 that can be turned ON to indicate the microphone is muted and/or one or more second microphones 866 that can be used, for example, for noise cancelling purposes.

A pulse density modulation inter-integrated circuit sound (PDM-I2S) circuit 862 can be coupled to microphone 864 (and microphone 866 if included) to convert the analog signal voltages generated by the microphones into a digital stream that can be then sent via a signal line (I2S) to a circuitry 842 in the connector end 840 of the boom microphone. In the depicted embodiment, two independent microphone signals can be received by PDM-I2S circuit 862 on separate Left and Right transport channels. As noted above, however, embodiments are not limited to the particular signal lines or communication protocols shown in FIG. 8, and other embodiments can rely on other communication protocols (including proprietary protocols) and signal lines to carry the microphone signal as can be determined by a person of ordinary skill in the art.

Circuitry 842 can include, for example, a microcontroller, an ASIC, a system on a chip (SoC), or similar components, along with one or more supporting circuits, including a voltage regulator (LDO) and/or a memory that stores an identifier (ID) that identifies boom microphone 830 as a boom microphone as compared to some other type of accessory device (e.g., a charging cable). When boom microphone 830 is initially connected to headphones 810, the ID can be sent to process/control circuitry 812 in headphones 810 over the ID bus 824.

The microcontroller can be configured to process the digital stream of audio data received from microphones 864, 866 and convert the received audio data to a format that can be transferred over data lines 822 (e.g., USB data lines) to headphones 810.

Connector end 840 can also include a mute button 844 that can be representative of mute button 436 discussed above. Circuitry 842 (e.g., the microcontroller) can receive an input from the mute button and turn LED 868 ON or OFF as appropriate over a signal line dedicated for the LED.

### Additional Embodiments

The foregoing description, for purposes of explanation, used specific nomenclature to provide a thorough understanding of the described embodiments. However, it will be apparent to one skilled in the art that the specific details are not required in order to practice the described embodiments. For example, while various examples of headphones described above were in the context of over-ear headphones, embodiments are not limited to over-ear headphones. In other embodiments the headphones can be on-ear (supra-aural) headphones or can be headsets that have a single earpiece for a user's left or right ear rather than a pair of earpieces for both ears. As another example, while the examples discussed above were all wireless headphones, in some embodiments the headphones can be wired headphones with a cord that connects the headphones to an audio source.

As still another example, while examples described above included a USB-C connector to exchange power and data between headphones 330 and the boom connector 400, embodiments are not limited to any particular connector format or protocol. In other embodiments, other types of connectors, including proprietary connectors can be used to provide power to the boom microphone and exchange data between the headphones and boom microphone. Additionally, in still other embodiments, the boom microphone can include its own power source (e.g., an internal, rechargeable battery) and the male and female connectors can be Lightning connectors, micro-USB connectors, or any other appropriately sized connector system that enables data to be exchanged between the boom microphone and headphones 330. In still other embodiments, the boom microphone can communicate with the headphones via Bluetooth or any other appropriate wireless communication protocol and can be attached to the headphones using any appropriate mechanical or magnetic attachment mechanism.

Thus, the foregoing descriptions of the specific embodiments described herein are presented for purposes of illustration and description. They are not intended to be exhaustive or to limit the embodiments to the precise forms disclosed. Also, while different embodiments of the invention were disclosed above, the specific details of particular embodiments may be combined in any suitable manner without departing from the spirit and scope of embodiments of the invention. Further, it will be apparent to one of ordinary skill in the art that many modifications and variations are possible in view of the above teachings.

Finally, it is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

What is claimed is:

1. Headphones comprising:
a headband having first and second opposing ends;
a first earpiece coupled to the first end of the headband and comprising a first audio driver;
a second earpiece coupled to the second end of the headband and comprising a second audio driver, wherein at least one of the first and second earpieces comprises a first directional microphone configured to and aligned to capture a user's voice;
a boom microphone configured to be removably attached to one of the first or second earpieces, the boom microphone comprising a second directional microphone disposed at a distal end of a flexible boom; and
a processor configured to, in response to detecting that the boom microphone is operably attached to the first or second earpiece, deactivate the first directional microphone.

2. The headphones set forth in claim 1 wherein the boom microphone further comprises a mute button that can be activated to mute the second directional microphone.

3. The headphones set forth in claim 1 wherein the boom microphone further comprises an LED at its distal end that can be switched ON and OFF by the processor to indicate whether the second directional microphone is muted or not.

4. The headphones set forth in claim 1 wherein at least one of the first and second earpieces comprises a receptacle connector having a receiving cavity and the boom microphone comprises a plug connector that can be inserted into the receiving cavity to operably connect the boom microphone to the headphones.

5. The headphones set forth in claim 1 wherein the boom microphone further comprises a third microphone configured to detect background noise behind the second microphone.

6. The headphones set forth in claim 1 wherein the boom microphone further comprises a computer-readable memory that stores an accessory identifier that can be communicated to the processor in the headphones to identify features of the boom microphone.

7. The headphones set forth in claim 1 further comprising a receptacle connector having an opening at an exterior surface of either the first or second earpiece.

8. The headphones set forth in claim 7 wherein the boom microphone includes plug connector having a tab sized and shaped to be inserted into the receptacle connector.

9. The headphones set forth in claim 8 wherein the receptacle connector is a USB-C port and the plug connector is USB-C plug connector.

10. Headphones comprising:
a headband having first and second opposing ends;
a first earpiece coupled to the first end of the headband and comprising a first audio driver aligned to direct sound towards a user's first ear when the headband is worn by the user, wherein the first earpiece comprises a receptacle connector having an opening at an exterior surface of the first earpiece;
a second earpiece coupled to the second end of the headband and comprising a second audio driver aligned to direct sound towards a user's second ear when the headband is worn by the user, wherein at least one of the first and second earpieces comprises a first directional microphone configured to and aligned to capture a user's voice when the headband is worn by the user;
a boom microphone comprising a plug connector and a second directional microphone disposed at opposite ends of an elongated flexible boom that can be bent into a desired position by a user and retain that position, wherein the boom microphone is configured to be removably attached to the first earpiece by inserting the plug connector into the opening of the receptacle connector to mate the plug connector to the receptacle connector; and
a processor configured to, in response to detecting that the boom microphone is operably attached to the first earpiece, deactivate the first directional microphone.

11. The headphones set forth in claim 10 wherein the boom microphone further comprises a mute button that can be activated to mute the second directional microphone.

12. The headphones set forth in claim 10 wherein the boom microphone further comprises an LED at its distal end that can be switched ON and OFF by the processor to indicate whether the second directional microphone is muted or not.

13. The headphones set forth in claim 10 wherein the boom microphone further comprises a third microphone configured to detect background noise behind the second microphone.

14. The headphones set forth in claim 10 wherein the boom microphone further comprises a computer-readable memory that stores an accessory identifier that can be communicated to the processor in the headphones to identify features of the boom microphone.

15. The headphones set forth in claim 10 wherein the plug connector has a connector tab extending away from a connector housing and a plurality of contacts disposed along the connector tab, the plurality of contacts comprising a power contact, a ground contact, and a pair of differential data contacts.

16. The headphones set forth in claim 10 wherein the second directional microphone is disposed within and coupled to a microphone housing and the headphones further comprise a windscreen disposed around the microphone housing and covering the second microphone.

17. The headphones set forth in claim 10 further comprising:
a pulse density modulation circuit operatively coupled to convert an analog signal voltage output of the microphone into a pulse density modulated digital stream; and
a microcontroller configured to receive the pulse density modulated digital stream and convert the digital stream to differential pairs that can be transmitted over a pair of differential data contacts on the plug connector.

18. A boom microphone comprising:
an elongated semi-rigid boom having a first and second opposing ends;
a plug connector disposed at the first end, the plug connector having a connector tab extending away from a connector housing and a plurality of contacts disposed along the connector tab, the plurality of contacts comprising a power contact, a ground contact, and a pair of differential data contacts;
a microphone housing disposed at the second end;
a directional microphone coupled to the microphone housing;
a pulse density modulation circuit disposed within the microphone housing and operatively coupled to convert an analog signal voltage output of the microphone into a pulse density modulated digital stream;
a microcontroller disposed within the connector housing and configured to receive the pulse density modulated digital stream and convert the digital stream to differential pairs that can be transmitted over the pair of differential data contacts;
wherein the elongated flexible boom is configured to be bent into a desired position and retain that position.

19. The boom microphone set forth in claim 18 wherein the boom microphone further comprises a computer-readable memory disposed within the connector housing and configured to store information identifying functionality associated with the boom microphone that can be communicated to the headphones.

20. The boom microphone set forth in claim 18 further comprising a mute button coupled to the connector housing and an LED coupled to the microphone housing, and wherein the microcontroller is operatively coupled to turn the LED ON in response to the mute button being activated.
